(19) United States
(12) Patent Application Publication
(10) Pub. No.: US 2007/0045278 A1
(43) Pub. Date: Mar. 1, 2007

(54) GLASS CERAMIC COOKTOP HAVING AT LEAST ONE BURNER

(75) Inventors: Hartmut Dittrich, Buende (DE); Joerg Vollgraf, Buende (DE)

Correspondence Address: DARBY & DARBY P.C., P. O. BOX 5257, NEW YORK, NY, 10150-5257, US

(73) Assignee: Miele & Cie. KG, Guetersloh (DE)

(21) Appl. No.: 11/466,031

(22) Filed: Aug. 21, 2006

(30) Foreign Application Priority Data
Aug. 23, 2005 (DE) 10 2005 040 041.8

(51) Int. Cl. H05B 3/68

(52) U.S. Cl. 219/446.1

(57) ABSTRACT

A glass ceramic cooktop includes at least one burner delimited in a radial direction by an inner wall of insulation, and a heating element disposed under the burner for heating up a cooking pot placed on the burner. A monitoring element is provided for limiting a heating temperature to a maximum value and to limit heat generated underneath the glass ceramic surface so as to limit heat radiated on the glass ceramic surface to a predefined value. A temperature switch is disposed underneath the glass ceramic surface outside of the burner in the radial direction. The temperature switch is configured to sense radially radiating heat released outside of the burner and, within a range of from about 130° C. to about 200° C., switch off the heating element.

Priority is claimed to German patent application 10 2005 040 041.8, filed Aug. 23, 2005, the entire subject matter of which is hereby incorporated by reference herein.

The present invention relates to a glass ceramic cooktop having at least one burner under which a heating element is arranged in order to heat up a cooking pot that is placed on the burner, as well as to a monitoring element that limits the heating temperature to a maximum value and that limits the heat being generated underneath the glass ceramic surface in order to limit the heat radiated on the glass ceramic surface to a safety-based value.

### BACKGROUND

The cooking start-up power of a glass ceramic cooktop generated by a heating element located underneath it is limited by two variables. First of all, the maximum glass ceramic temperature has to be observed so that the service life of the glass ceramic is safeguarded under various types of load such as, for example, a pot that is incorrectly positioned, a pot that is too small or a pot that has boiled dry. Moreover, a wall that is located next to or behind the burner must not become so hot that it catches fire, also if there is no pot on the burner. This is especially important with the built-in cooktops since here, the cooktop and the walls of built-in cabinetry are inevitably installed in close proximity to each other. Both of these aspects are taken into account by a monitoring element that interacts with the heating element and that switches it off at a temperature of approximately 700° C.

According to the state of the art, the monitoring element described above, which switches off the burner at a predefined value is known, for example, from WO 01/62049, WO 01/62047 and WO 01/62046.

The state of the art also describes temperature-dependent resistors in conjunction with an electronic unit that ensure compliance with the maximum permissible temperature. Thus, for example, DE 40 22 844 discloses a method for detecting and displaying an abnormal thermal load state on a heating surface made of glass ceramic and in this method, temperature sensors are arranged independently of each other in the area of a heating zone and they ascertain characteristic temperature distributions in the heating surface for a certain abnormal thermal load state, subsequently displaying this visually and/or acoustically by means of operating state displays. This method is intended to detect and display the load state in a heating surface made of glass ceramic or of a comparable material. Here, it should be ensured that, depending on the use of a heating surface, it is possible to prevent certain causes of abnormal thermal load states such as, for example, the typical incorrect positioning of pots, which occurs time and again.

The incorrect positioning of pots or else the use of pots of poor quality can lead to overheating of the cooking surface in an inner area or only in an outer area of the cooking zone or else in both areas together. Thus, for example, in the case of an incorrectly positioned pot or a pot with contact surfaces that bulge outwards or a pot that is too small, only an outer ring-shaped edge area of the cooking zone or only a segment of this area is overheated. Therefore, in order to rule out especially such incorrect positioning, the method known from the state of the art proposes providing several temperature sensors that are arranged independently of each other in the area of the heating zone and that detect a characteristic temperature distribution for a certain abnormal thermal load state in the heating surface in order to, in this manner, use visual or acoustic warning devices to indicate to the user that the cookware is incorrectly positioned.

DE 37 03 768 C2 describes a glass ceramic cooktop having at least one burner that is delimited in the radial direction by the inner wall of an insulation and that has a heating element underneath it for purposes of heating up a cooking pot that is temperature to a maximum value and that limits the heat being generated underneath the glass ceramic surface in order to limit the heat radiated on the glass ceramic surface to a predefined value, whereby a temperature switch is arranged in the radial direction outside of the burner underneath the glass ceramic surface and said temperature switch senses the radially radiating heat released outside of the burner.

Recent times have seen the advent of glass ceramics that have an improved service life and that allow higher temperatures. However, since standard regulations do not permit wooden partition walls to have higher rod expansion temperatures, this advantage of a better quality glass ceramic cannot be utilized with the current heating elements. Through the use of an electronic monitoring system, the surface temperature of the glass ceramic can have a high initial value—thus accounting for a rapid cooking start-up function—which is then reduced incrementally so that the maximum partition wall temperature of approximately 175° C. is observed. However, this entails very high requirements in terms of the electronic monitoring system in order to fulfill the safety functions, which makes the electronic system very expensive.

### SUMMARY

It is an object of the present invention to provide a glass ceramic cooktop having a monitoring element arranged above the heating element, an improved cooking start-up power, the safety required in partition wall areas near the glass ceramic cooktop, and low costs for the monitoring system.

The invention is based on a heating element that is arranged under the glass ceramic surface and above which a monitoring element is arranged that is configured as a rod expansion element. Due to the temperature that is set at a fixed value, the rod expansion element is adjusted in such a manner that it takes into consideration both maximum temperature values, namely, for the glass ceramic and for the wall.

The present invention provides a glass ceramic cooktop including at least one burner delimited in a radial direction by an inner wall of insulation, and a heating element disposed under the at least one burner and configured to heat up a cooking pot placed on the burner. A monitoring element is included that is configured to limit a heating temperature to a maximum value and to limit heat generated underneath the glass ceramic surface so as to limit heat radiated on the glass ceramic surface to a predefined value. A temperature switch is disposed underneath the glass ceramic surface outside of the burner in the radial direction. The temperature switch is configured to sense radially radiating heat released outside of the burner and, within a range of from about 130° C. to about 200° C., switch off the heating element.

### BRIEF DESCRIPTION OF THE DRAWINGS

An embodiment of the present invention is explained in greater detail with reference to the accompanying drawings, in which the following is shown:

FIG. 1: a top view of a burner; and

FIG. 2: a cutaway side view of the glass ceramic cooktop with a heating element arranged underneath it and with a pot placed on it.

### DETAILED DESCRIPTION

A temperature switch is arranged in the radial direction outside of the burner underneath the glass ceramic surface and, within a range of about 130° C. to 200° C., the temperature switch switches off the heating element that serves to heat up the burner. In this manner, a temperature switch is provided that prevents overheating of the wall, while the monitoring element arranged above the heating element primarily protects the glass ceramic from overheating.

Preferably, the monitoring element limits the heat being generated underneath the glass ceramic surface to a temperature of 800° C. to 900° C.

In an embodiment of the glass ceramic cooktop, the temperature switch is attached directly to the glass ceramic surface so that only the temperature developing on the glass ceramic surface is measured. Here, the temperature switch as such, which is set at a fixed value, preferably comprises a wave washer thermostat or the like. It is set at a limit value in a range between about 130° C. and 220° C. so that the heating element for heating up the burner then switches off at the limit temperature that has been predefined and selected from this temperature range.

Due to the arrangement according to the invention of a temperature switch, it is achieved that the temperature underneath the glass ceramic is detected radially outside of the burner. Accordingly, the temperature switch can be arranged either in the insulation delimiting the burner or else in the radial direction outside of the insulation. In this manner, the heating element may not have a direct influence on the temperature switch, so that the temperature switch supplies a usable signal to the cooktop controls.

If, for example, a wave washer thermostat is used as the temperature switch, it can be integrated directly into the circuit for the heating element so that, in this case, there is no need for a signal transmission connection to the cooktop controls. Otherwise, if the temperature switch were arranged within the burner, the heating element would influence the output signal of the temperature switch to such an extent that the cooktop controls might not be able to distinguish between a desired state, namely, that a cooking pot has been placed onto the burner of the glass ceramic cooktop, and an undesired state, namely, that no cooking pot has been placed there.

If the temperature underneath the glass ceramic is limited in the radial direction outside of the burner, for example, by means of a wave washer thermostat, the monitoring element can be operated at a high switch-off setting, that is to say, at a high maximum value for the switch-off temperature. Thus, on the one hand, the advantage of a high-quality glass ceramic is utilized and, on the other hand, a faster cooking start-up can be achieved.

Since the temperature switch, namely, the wave washer thermostat, assumes the task of protecting the partition wall, the monitoring element, namely, the rod expansion element, only has to protect the glass ceramic and can therefore be set to a higher value, since the glass ceramic allows this. The result is a faster cooking start-up, especially when poor-quality pots are used.

Here, the temperature switch is arranged in the radial direction outside of the burner underneath the glass ceramic surface so that it senses the radially radiating heat release. It has a switch-off temperature of about 130° C. to 200° C. During proper use, this temperature is not reached because the bottom of the pot cools the glass ceramic surface in the area of the heating element. However, if the glass ceramic surface is no longer being cooled, for example, because the burner is being operated without a pot, then the heating element is automatically switched off. A temperature switch located on the outside in the radial direction is better able to recognize the load case of “no pot” and thus protect the wall than a monitoring element that is arranged exclusively above the heating element.

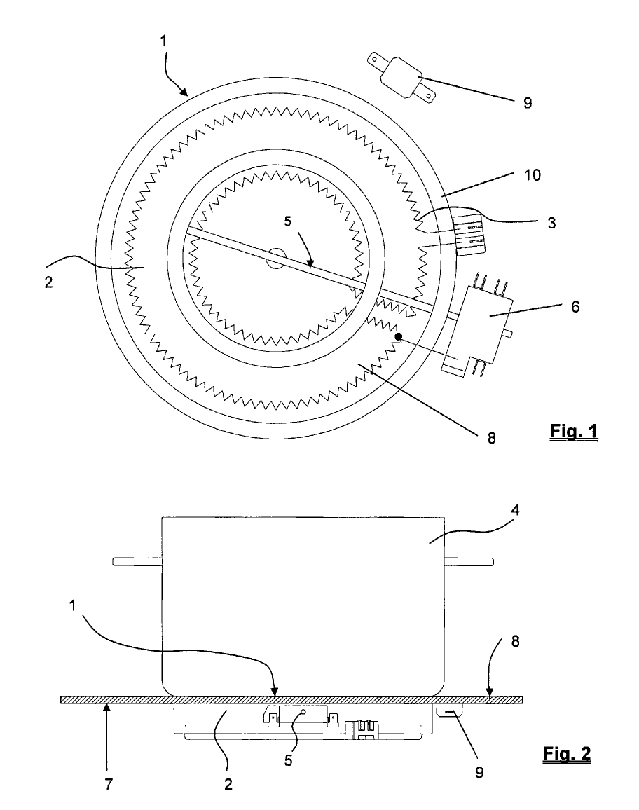

FIGS. 1 and 2, when viewed together, show a glass ceramic cooktop 1 having at least one burner 2, with a heating element 3 in the form of a heating coil arranged underneath the burner 2. The burner 2 is limited in the radial direction by the inner wall of an insulation 10. The depiction presented there according to FIG. 1 shows a heating element 3 in a two-circuit version. The heating element 3 is intended to heat up a cooking pot 4 positioned above the burner 2 on the glass ceramic cooktop 1. The heating element 3 also comprises a monitoring element 5 that limits the heating temperature to a maximum value and that is configured as a rod expansion element 6 arranged above the heating coil.

This rod expansion element 6 is set in such a way that the heat being generated underneath the glass ceramic surface 7 is preferably limited to a temperature of about 800° C. to 900° C. so that, for safety reasons, the heat radiating on the glass ceramic surface 8 does not exceed a temperature in the range from about 500° C. to 600° C. This is also important so that the adjacent partition wall surfaces that are situated at a certain distance from the burner 2 are not detrimentally affected. Consequently, the heat being generated on the glass ceramic surface 8 is reduced, for example, when a cooking pot 4 has been placed on the glass ceramic surface 8, as shown in FIG. 2.

The heat released in the burner 2 of a glass ceramic cooktop 1 can now be utilized more advantageously, as a result of which especially the cooking start-up times are reduced, namely, in that a temperature switch 9 is arranged in the radial direction outside of the burner 2 underneath the glass ceramic surface 7 and said temperature switch 9 senses and limits the radially radiating heat release.

As a result, the effect is achieved that now the rod expansion element 6 can be set at a higher temperature limit value so that the heating-up rate for the food contained in the cooking pot 4 is increased. If the temperature switch 9 arranged outside of the burner 2 underneath the glass ceramic surface 7 senses a certain heat release, then said temperature switch 9 switches off the heating element 3. This enables, on the one hand, the cooking start-up time to be reduced and as a result, on the other hand, the partition wall to be also properly protected. The temperature switch 9 is attached directly to the glass ceramic surface 7 so that it measures exclusively the heat being generated on the glass ceramic surface 7.

Here, the temperature switch 9 is set within a range of about 130° C. to 200° C. so that, when the heating element 3 that serves to heat up the burner 2 reaches a limit temperature that has been predefined and selected from this temperature range, said heating element 3 automatically switches off.

In an embodiment of the invention, the temperature switch 9 is configured as a wave washer thermostat.

The invention is to be understood to be not limited to the embodiments described.

What is claimed is:

1. A glass ceramic cooktop comprising:
at least one burner delimited in a radial direction by an inner wall of insulation;
a heating element disposed under the at least one burner and configured to heat up a cooking pot placed on the burner;
a monitoring element configured to limit a heating temperature to a maximum value and to limit heat generated underneath the glass ceramic surface so as to limit heat radiated on the glass ceramic surface to a predefined value; and
a temperature switch disposed underneath the glass ceramic surface outside of the burner in the radial direction, the temperature switch being configured to sense radially radiating heat released outside of the burner and, within a range of from about 130° C. to about 200° C., switch off the heating element.

2. The glass ceramic cooktop as recited in claim 1 wherein the monitoring element is configured to limit the heat generated underneath the glass ceramic surface to a temperature of from about 800° C. to about 900° C.

3. The glass ceramic cooktop as recited in claim 1 wherein the temperature switch is attached directly to the glass ceramic surface.

4. The glass ceramic cooktop as recited in claim 2 wherein the temperature switch is attached directly to the glass ceramic surface.

5. The glass ceramic cooktop as recited in claim 1 wherein the temperature switch includes a wave washer thermostat.

6. The glass ceramic cooktop as recited in claim 2 wherein the temperature switch includes a wave washer thermostat.

7. The glass ceramic cooktop as recited in claim 3 wherein the temperature switch includes a wave washer thermostat.

8. The glass ceramic cooktop as recited in claim 4 wherein the temperature switch includes a wave washer thermostat.
